(19) United States
(12) Patent Application Publication
(10) Pub. No.: US 2019/0304033 A1
(43) Pub. Date: Oct. 3, 2019

(54) System and method to allow verification of income and/or verification of employment for a US Citizen or person using Federal employment tax deposit data, also known as FICA taxes collected by the IRS and reported to the IRS, SSA, Medicare or other US Government sources deposited by a person's employer or through tax payments and filings of self-employed persons.

(71) Applicant: David Johnson, Catharpin, VA (US)

(72) Inventor: David Johnson, Catharpin, VA (US)

(21) Appl. No.: 15/942,390

(22) Filed: Mar. 30, 2018

(51) Int. Cl. G06Q 40/00; G06Q 50/26

(52) U.S. Cl. CPC G06Q 40/125; G06Q 50/26

(57) ABSTRACT

This is a system and method that will allow a person to give permission for a US government agency to release the dollar amount of their withholding for FICA (Federal Insurance Contributions Act) consisting of Social security tax and Medicare tax. The release of this information will be for a specified amount of time (example of 1 year, 2 years, 3 years, etc.) to a designated third party (hereinafter referred to patent holder). Once this information is released to a certified third party (hereinafter referred to as the patent holder) this information will be used to reverse engineer the gross pay of a person and may also include the entity (employer) that made the payment.

Companies are required to submit FICA taxes annually, quarterly, monthly or semiweekly depending on the size of the deposit. This is valuable date and the release of the amount of tax for a person will allow the TPPH to reverse engineer via mathematical calculation based on tax rate to determine the gross pay of a person

Once the designated third party obtains this information, the information will be formatted to produce a Verification of Employment w/income that is consummate with the VOE's that are currently used across industries (example, mortgage, tenant screening, etc.) this information may also be furnished to prospective employers to verify the past income of an applicant.

This Gross pay would be released to other third parties at the discretion of the person initiating the request. For example, a person applying for a mortgage or to lease an apartment would authorize the patent holder to present an annual/monthly or weekly income to the entity. The patent holder would then furnish a report based on that information.

### BACKGROUND

Unfulfilled Needs: Under the current verification of employment, one large player exists that has created a monopoly with approx. 30% of the employers in the United States. The Work Number, owned by Equifax has contracts with employers and mandates that only they can receive employment and income information. This has led to a substantial increase in cost as there is no other alternative to obtain the data from a verified source. As of May, 1, TWN has also implemented a monthly fee of $25-$5,000 per month for each entity that would like the ability to obtain this data. On top of this fee, they pay a cost per report that can exceed $30.00 per person.

This system and method will allow another alternative to obtaining employment information outside of the monopoly that exists today. Furthermore, this will allow the SSA to create a revenue center by selling this information similar to the way the IRS currently sells access to a citizens Tax return Transcript via the 4506t form.

1. The consumer will use a mobile application, web site and or like communication to generate an order that will go either through the patent owner's system or directly to the GSA (Internal Revenue Service, Social Security Admin or Medicare). The uses will authenticate their identity using current acceptable technologies. Once authenticated, data that consists in part or completely amount of FICA withholding for the last available reporting period, last year and late two years or any time set forth by GSA or patent holder. The data packet will also send the name of the employer and EIN if available.

2. When the information is returned to the (TPPH), the TPPH will then use the data to reverse engineer the annual, monthly or weekly income of a citizen. The formula will consist of dividing out the current taxation rate into the dollar amount. This will then become the TPPH verified income.

3. The TPPH income will then merge into a standard form created by TPPH and populate with additional information such as employer, depositor of funds, date time, consistency, etc.

4. If there are any arrears in the reporting, they may be notated inside the data package if provided.

5. This TPPH form will be sold or transferred on the open market to participants and released with the permission and authorization of the citizen.

6. The data package will remain inside the TPPH database and may be updated or used at a future date according to contractual relationship with citizen and GSA
